(19) United States
(12) Patent Application Publication
(10) Pub. No.: US 2026/0245819 A1
(43) Pub. Date: Aug. 20, 2026

(54) ELECTROMAGNETIC RELAY

(71) Applicant: OMRON Corporation, Kyoto-shi, Kyoto (JP)

(72) Inventors: Ayata HORIE, Kyoto-shi, Kyoto (JP); Shinichi OGAWA, Kyoto-shi, Kyoto (JP); Naoki KAWAGUCHI, Kyoto-shi, Kyoto (JP)

(21) Appl. No.: 19/161,272

(22) PCT Filed: Feb. 20, 2024
(86) PCT No.: PCT/JP2024/006038

§ 371 Date: Sep. 1, 2025

(30) Foreign Application Priority Data
Mar. 14, 2023 (JP) 2023-039487

(51) Int. Cl. H01H 50/02; H01H 50/54

(52) U.S. Cl. CPC H01H 50/02; H01H 50/546

(57) ABSTRACT

An electromagnetic relay includes a case, a drive device, a contact device, a conductive member, and a heat-receiving member. The drive device is disposed inside the case. The contact device is disposed adjacent to the drive device inside the case. The conductive member is connected to the contact device inside the case. The heat-receiving member is disposed inside the case. The heat-receiving member contacts at least a portion of the conductive member and receives heat from the conductive member.

### CROSS-REFERENCE TO RELATED APPLICATION

This application is the U.S. National Phase of International Application No. PCT/JP2024/006038, filed on Feb. 20, 2024. This application claims priority to Japanese Patent Application No. 2023-039487, filed Mar. 14, 2023. The contents of those applications are incorporated by reference herein in their entireties.

### TECHNICAL FIELD

The claimed invention relates to an electromagnetic relay.

### BACKGROUND ART

In an electromagnetic relay, a conductive member is used as a current path to pass electricity from a contact device to an external device. In the electromagnetic relay disclosed in Japanese Patent No. 7117567, referring to FIG. 9, a plurality of bent portions is formed on the conductive member. Flexibility of the layout of the external device relative to the electromagnetic relay is ensured by forming the plurality of bent portions in this manner.

### SUMMARY

In a case in which the conductive member is bent in various directions as the conventional electromagnetic relay, a length of the conductive member increases and a weight of the conductive member increases. In this case, when a vibration is applied to the electromagnetic relay, the conductive member moves from the predetermined design position.

In addition, in a case in which a fixing member such as a screw is provided in the current path of the conductive member to restrict movement of the conductive member, current-carrying efficiency of the conductive member is reduced. In this case, it is also necessary to guide the conductive member to a position that faces a member to which the fixing member can be fixed. In this case, the shape of the conductive member becomes complicated.

An object of the present invention is to provide an electromagnetic relay which can maintain a current path of a conductive member without reducing the current-carrying efficiency of the conductive member.

### Solution to Problems

An electromagnetic relay according to one aspect of the claimed invention includes a case, a drive device, a contact device, and a conductive member. The drive device is disposed inside the case. The contact device is disposed adjacent to the drive device inside the case. The conductive member includes a current-carrying portion and a holding portion. The current-carrying portion is connected to the contact device and forms a current path. The holding portion is provided on the current-carrying portion. The holding portion is held by at least one of the case and the drive device.

In the electromagnetic relay, the current path of the conductive member is ensured by the current-carrying portion. The holding portion of the conductive member is held by at least one of the case and the drive device, and movement of the conductive member is restricted. Thus, the current path of the conductive member can be maintained without reducing the current-carrying efficiency of the conductive member in this electromagnetic relay.

The holding portion can be disposed between the case and the drive device and can be held by the case. The holding portion can be disposed between the case and the drive device and can be held by the drive device. The drive device can include a coil and a yoke disposed between the coil and the case. In this case, the holding portion is fixed to the yoke. Even with this configuration, the current path of the conductive member can be maintained without reducing the current-carrying efficiency of the conductive member.

The contact device can include a first terminal portion and a second terminal portion disposed at an interval from the first terminal portion. In this case, the current-carrying portion includes a first current-carrying portion which is connected to the first terminal portion and a second current-carrying portion which is connected to the second terminal portion. The holding portion includes a first holding portion which is provided on the first current-carrying portion and a second holding portion which is provided on the second current-carrying portion. Even with this configuration, the current path of the conductive member can be maintained without reducing the current-carrying efficiency of the conductive member.

### Advantageous Effects of Invention

According to the present invention, an electromagnetic relay can maintain a current path of a conductive member without reducing the current-carrying efficiency of the conductive member.

### BRIEF DESCRIPTION OF THE DRAWINGS

FIG. 1 is a perspective view of an electromagnetic relay.

FIG. 2 is a front view of the electromagnetic relay.

FIG. 3A is a perspective view of a first conductive member.

FIG. 3B is a perspective view of a second conductive member.

FIG. 4 is a partially enlarged cross-sectional view of the vicinity of first and second holding portions.

FIG. 5 is a partially enlarged cross-sectional view of the vicinity of the first and second holding portions in a modified example.

FIG. 6 is a perspective view of the electromagnetic relay according to a modified example.

### DETAILED DESCRIPTION

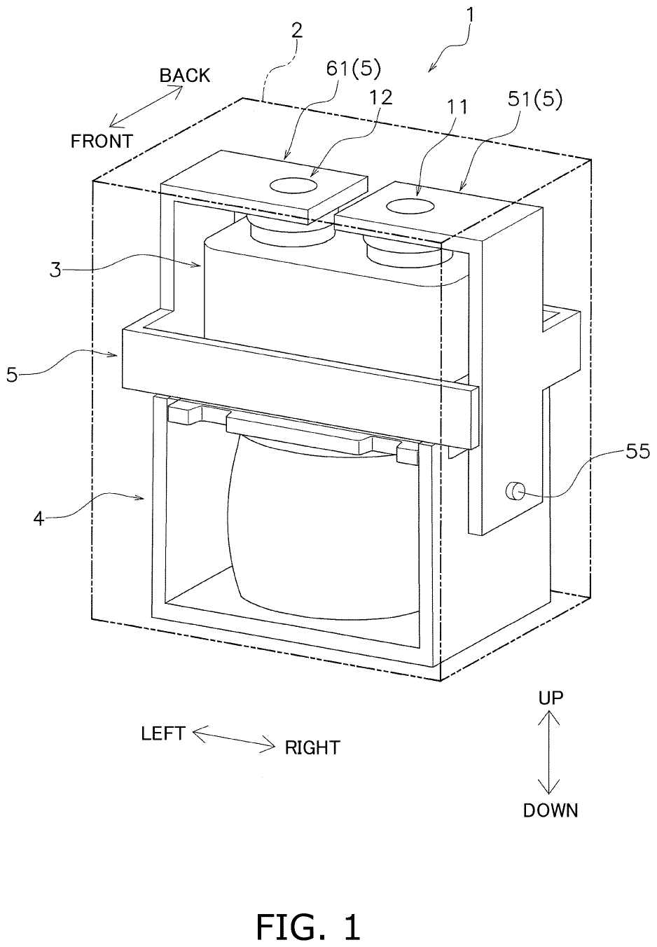

Hereinafter, an exemplary embodiment of an electromagnetic relay 1 in accordance with the claimed invention will be described with reference to the drawings. As shown in FIG. 1, the electromagnetic relay 1 includes a case 2, a contact device 3, a drive device 4, and a conductive member 5. In the following description, a direction in which the contact device 3 and the drive device 4 are disposed with respect to the bottom of the case 2 is defined as an upward direction. The opposite direction to the upward direction is defined as a downward direction.

A direction in which a first fixed terminal 11 and a second fixed terminal 12, which is described later, are disposed side by side is defined as a left-right direction. A direction perpendicular to the left-right direction and a vertical direction is defined as the front-back direction. These directions are defined for the convenience of explanation and do not limit an arrangement direction of the electromagnetic relay 1.

As shown in FIG. 1, the case 2 is formed in a box shape. The case 2 is made of an insulating material such as resin. The case 2 accommodates the contact device 3 and the drive device 4. The contact device 3 is disposed adjacent to the drive device 4 inside the case 2. For example, the contact device 3 is disposed above the drive device 4 inside the case 2.

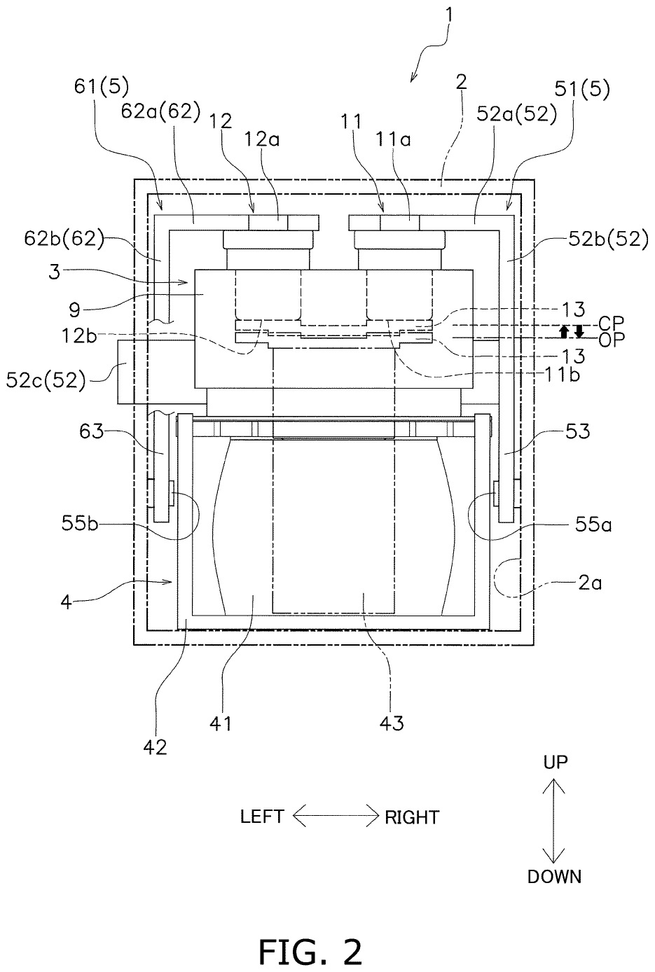

As shown in FIG. 2, the contact device 3 includes a contact case 10, the first fixed terminal 11 (an example of a first terminal portion), the second fixed terminal 12 (an example of a second terminal portion), and a movable contact piece 13.

As shown in FIG. 2, the contact case 10 is disposed inside the case 2. The contact case 10 is disposed on an upper portion of the drive device 4.

The first fixed terminal 11, the second fixed terminal 12, and the movable contact piece 13 is disposed on the contact case 10.

As shown in FIG. 2, the first and second fixed terminals 11, 12 are terminals for connecting an external circuit. The first and second fixed terminals 11, 12 are made of a conductive material such as copper or a copper alloy. The conductive material can be a material other than copper or a copper alloy.

The first and second fixed terminals 11, 12 are disposed at an interval from each other. For example, the first and second fixed terminals 11, 12 are disposed at an interval in the left-right direction. The first and second fixed terminals 11, 12 are supported by the contact case 10.

The first and second fixed terminals 11, 12 are formed in a substantially cylindrical shape. Upper ends 11a, 12a of the first and second fixed terminals 11, 12 protrude from an upper surface of the contact case 10. The upper end 11a of the first fixed terminal Il is connected to a first conductive member 51 which is described later. The upper end 12a of the second fixed terminal 12 is connected to a second conductive member 61 which is described later.

As shown in FIG. 2, the movable contact piece 13 is a plate-like terminal which is long in one direction. The movable contact piece 13 is made of a conductive material such as copper or a copper alloy. The conductive material can be a material other than copper or a copper alloy.

The movable contact piece 13 is disposed below the first and second fixed terminals 11, 12. The movable contact piece 13 is disposed below the first and second fixed terminals 11, 12 so as to face the first and second fixed terminals 11, 12.

As shown in FIG. 2, the drive device 4 moves the movable contact piece 13. For example, the drive device 4 moves the movable contact piece 13 in the vertical direction. Specifically, the drive device 4 moves the movable contact piece 13 between a closed position CP in which the movable contact piece 13 contacts the lower ends 11b, 12b of the first and second fixed terminals 11, 12, and an open position OP in which the movable contact piece 13 moves away from the first and second fixed terminals 11, 12. In FIG. 2, the movable contact piece 13 positioning at the closed position CP is indicated by a dashed line, and the movable contact piece 13 positioning at the open position OP is indicated by a two-dot dashed line.

The drive device 4 is disposed inside the case 2. The drive device 4 is disposed below the movable contact piece 13. The drive device 4 includes a coil 41 and a yoke 42. The coil 41 is disposed below the movable contact piece 13.

The movable contact piece 13 is disposed in the open position OP or the closed position CP by switching a voltage application state applied to the coil 41. For example, when no voltage is applied to the coil 41, the movable contact piece 13 is disposed on the open position OP by a return structure (not shown) of a moving structure 43. In this state, the first and second fixed terminals 11, 12 are not electrically connected.

When a voltage is applied to the coil 41, a magnetic field is generated around the coil 41. This magnetic field activates a magnetic attraction structure of the moving structure 43, and the movable contact piece 13 moves from the open position OP to the closed position CP. As a result, the movable contact piece 13 abuts on the first and second fixed terminals 11, 12. In this state, the first and second fixed terminals 11, 12 are electrically connected via the movable contact piece 13.

The detailed description of the configuration of the moving structure 43 (the returning structure and the magnetic attraction structure) is omitted, since the configuration of the moving structure 43 (the returning structure and magnetic attraction structure) is the same as the configuration of the conventional technology.

As shown in FIG. 2, the yoke 42 is disposed between the coil 41 and the case 2. The yoke 42 is disposed so as to surround the coil 41. For example, the yoke 42 includes a shape which is bent into a C-shaped. The yoke 42 is disposed so as to surround a lower surface of the coil 41, both side surfaces of the coil 41, and an upper surface of the yoke 42.

As shown in FIGS. 1 and 2, the conductive member 5 is connected to the contact device 3 inside the case 2. The conductive member 5 includes the first conductive member 51 and the second conductive member 61. The first and second conductive members 51, 61 are made of a conductive material such as copper or a copper alloy. The conductive material can be a material other than copper or a copper alloy. The first and second conductive members 51, 61 are formed by bending a strip-shaped metal plate.

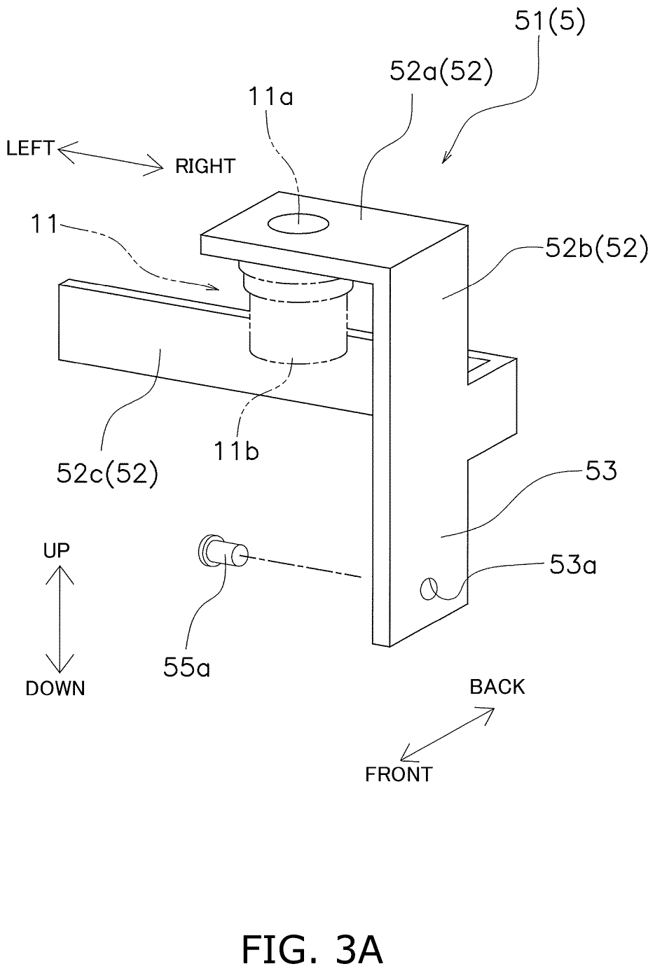

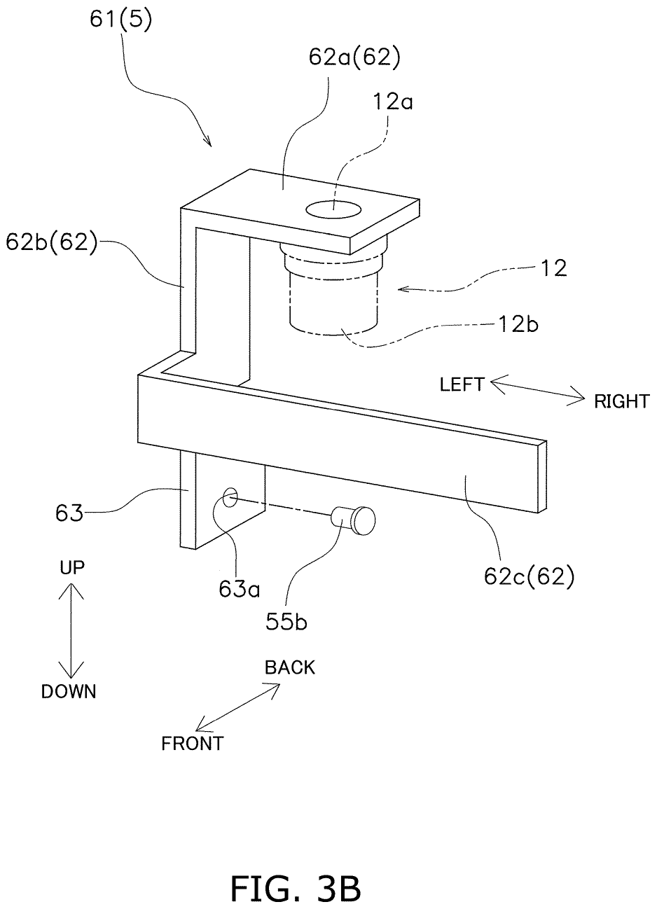

As shown in FIG. 3A, the first conductive member 51 includes a first current-carrying portion 52 and a first holding portion 53 (an example of a holding portion). The first current-carrying portion 52 is connected to the contact device 3 and forms a current path. For example, as shown in FIG. 2, the first current-carrying portion 52 is connected to the first fixed terminal 11.

As shown in FIG. 3A, the first current-carrying portion 52 includes a first connection portion 52a, a first extension portion 52b, and a first electric-path portion 52c. The first connection portion 52a, the first extension portion 52b, and the first electric-path portion 52c form the current path.

As shown in FIGS. 2 and 3A, one end of the first connection portion 52a is connected to the upper end 11a of the first fixed terminal 11. The first connection portion 52a extends in a direction from the second fixed terminal 12 toward the first fixed terminal 11, for example, to the right side away from the first fixed terminal 11.

The first extension portion 52b is disposed so as to face a right side wall of the case 2. The first extension portion 52b extends from the other end of the first connection portion 52a along a side portion of the first fixed terminal 11. For example, one end of the first extension portion 52b is connected to the other end of the first connection portion 52a. In this state, the first extension portion 52b extends from the other end of the first connection portion 52a to a down side along the side portion of the first fixed terminal 11. More specifically, the first extension portion 52b further extends rearward after the first extension portion 52b extends from the other end of the first connection portion 52a to the down side along the side portion of the first fixed terminal 11.

The first electric-path portion 52c is disposed so as to face a rear wall of the case 2. The first electric-path portion 52c extends from the other end of the first extension portion 52b in the left-right direction. For example, the first electric-path portion 52c extends from the other end of the first extension portion 52b to a left side. As shown in FIG. 2, the first electric-path portion 52c passes behind the contact device 3, for example, behind the contact case 10. In a state where the movable contact piece 13 is disposed on the closed position CP, the first electric-path portion 52c is disposed between the movable contact piece 13 and the yoke 42 in the vertical direction.

As shown in FIGS. 2 and 3A, the first holding portion 53 is provided on the first current-carrying portion 52. Specifically, the first holding portion 53 is provided on the first current-carrying portion 52 so as to be out of the current path of the first current-carrying portion 52. In this embodiment, the first holding portion 53 is provided on a lower portion of the first extension portion 52b. The first holding portion 53 extends from the lower portion of the first extension portion 52b to the down side. As shown in FIG. 3A, the first holding portion 53 is provided with a hole 53a for inserting a screw member 55a (described later) therethrough.

The first holding portion 53 is formed integrally with the first extension portion 52b. The first holding portion 53 can be formed separately from the first extension portion 52b. In this case, the first holding portion 53 is attached to the first extension portion 52b as a separate member.

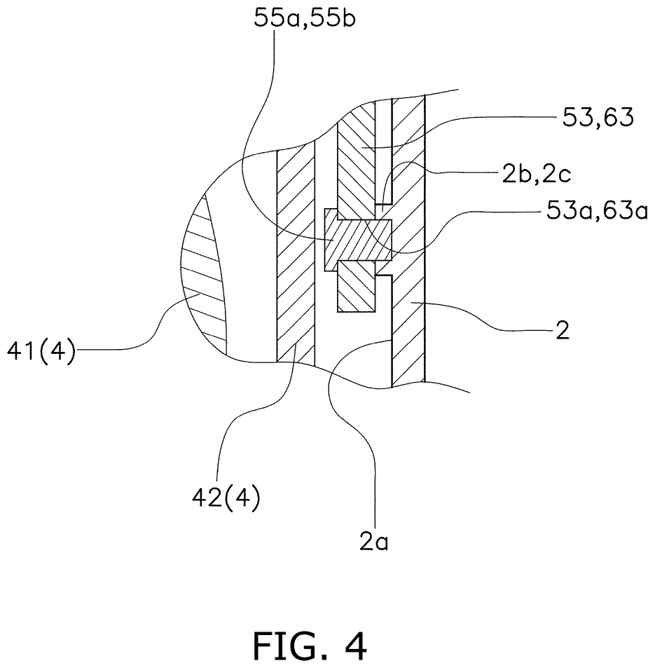

As shown in FIGS. 2 and 4, the first holding portion 53 is held by the case 2. For example, the first holding portion 53 is disposed between the case 2 and the drive device 4. The first holding portion 53 is fixed to an inner surface 2a of the case 2 by the screw member 55a. More specifically, as shown in FIG. 4, the first holding portion 53 is fixed to a boss portion 2b, which is provided on the inner surface 2a of the case 2, by the screw member 55a.

In this embodiment, the screw member 55a is used as a fixing member. The fixing member can be another member. For example, the first holding portion 53 can be fixed to the inner surface 2a of the case 2 by a fixing member such as an adhesive.

As shown in FIG. 3B, the second conductive member 61 includes a second current-carrying portion 62 and a second holding portion 63 (an example of a holding portion). The second current-carrying portion 62 includes a second connection portion 62a, a second extension portion 62b, and a second electrical path portion 62c.

The configuration of the second conductive member 61 is substantially the same as the configuration of the first conductive member 51, except for the arrangement of the second conductive member 61. For example, the configuration of the second conductive member 61 can be understood by replacing “first” with “second” and “right” with “left” in the above description of the first conductive member 51.

Therefore, the configuration of the second conductive member 61 is briefly described. The second connection portion 62a extends in a direction from the first fixed terminal 11 toward the second fixed terminal 12, for example, to the left side away from the second fixed terminal 12. The second extension portion 62b further extends forward after the second extension portion 62b extends from the second connection portion 62a to the down side along the side portion of the second fixed terminal 12. The second electrical path portion 62c passes in front of the contact device 3, for example, in front of the contact case 10.

In the second conductive member 61, the second holding portion 63 is fixed to the inner surface 2a of the case 2 by a screw member 55b. Specifically, as shown in FIG. 4, the second holding portion 63 is fixed to a boss portion 2c, which is provided on the inner surface 2a of the case 2, by the screw member 55b.

In this embodiment, the screw member 55b is used as the fixing member. The fixing member can be another member. For example, the second holding portion 63 can be fixed to the inner surface 2a of the case 2 by a fixing member such as an adhesive.

In the above-mentioned electromagnetic relay, the current paths of the conductive member 5 (the first and second conductive members 51, 61) is ensured by the first and second current-carrying portions 52, 62. The first and second holding portions 53, 63 of the conductive member 5 are disposed between the case 2 and the drive device 4, and are held by the case 2. As a result, movement of the conductive member 5 is restricted by the case 2. Thus, the current path of the conductive member 5 can be maintained without reducing the current-carrying efficiency of the conductive member 5 in the electromagnetic relay 1.

Although one embodiment of the present invention has been described above, the present invention is not limited to the above embodiment, and various modifications are possible without departing from the gist of the invention.

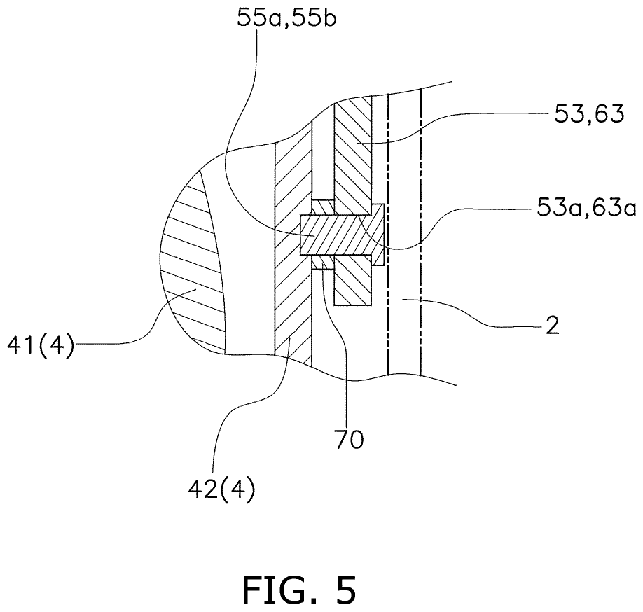

In the above embodiment, an example in which the first and second holding portions 53, 63 are held by the case 2 has been shown. As shown in FIG. 5, the first and second holding portions 53, 63 can be held by the drive device 4.

In this case, the first and second holding portions 53, 63 are disposed between the case 2 and the drive device 4. For example, the first and second holding portions 53, 63 are fixed to the yoke 42 by the screw members 55a, 55b.

Specifically, the first and second holding portions 53, 63 are fixed to the yoke 42 by the screw members 55a and 55b via a spacer 70. The fixing member can be another member as in the previous embodiment. For example, the first and second holding portions 53, 63 can be fixed to the yoke 42 by a fixing member such as an adhesive.

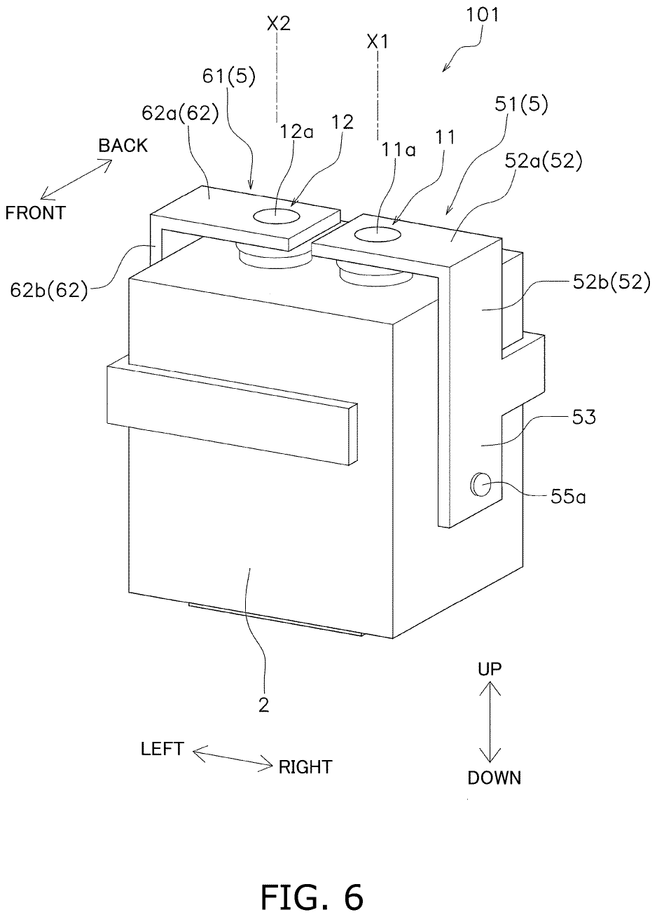

In the above embodiment, an example in which the upper ends 11a, 12a of the first and second fixed terminals 11, 12 of the contact device 3 are disposed inside the case 2 has been shown. An electromagnetic relay 101 can be configured as shown in FIG. 6. In the electromagnetic relay 101, the upper ends 11a, 12a of the first and second fixed terminals 11, 12 of the contact device 3 are disposed outside the case 2.

In this case, the conductive member 5 is connected to the contact device 3 outside the case 2. For example, the first connection portion 52a and the first extension portion 52b of the first conductive member 51 are disposed outside the case 2. The first connection portion 52a is connected to the upper end 11a of the first fixed terminal 11 on an outside of the case 2 and extends to the right side. The first extension portion 52b extends from the first connection portion 52a to the down side along an outer surface of the right side wall of the case 2. The first holding portion 53 extends from the first extension portion 52b to the down side along the outer surface of the right side wall of the case 2.

The second connection portion 62a and the second extending portion 62b of the second conductive member 61 are disposed outside the case 2. For example, the second connection portion 62a is connected to the upper end 12a of the second fixed terminal 12 on the outside of the case 2 and extends to the left side. The second extension portion 62b extends from the second connection portion 62a to the down side along an outer surface of a left side wall of the case 2. The second holding portion 63 (not shown in FIG. 6) extends from the second extension portion 62b to the down side along the outer surface of the left wall of the case 2.

The first and second holding portions 53, 63 are fixed to an outer surface of the case 2 by the screw members 55a, 55b. The fixing member can be another member as the previous embodiment. For example, the first and second holding portions 53, 63 can be fixed to the outer surface of the case 2 by a fixing member such as an adhesive.

Even with this configuration, the current paths of the conductive member 5 (the first and second conductive members 51, 61) can be ensured by the first and second current-carrying portions 52, 62, and the movement of the conductive member 5 can be restricted by the case 2. As a result, the current path of the conductive member 5 can be maintained without reducing the current-carrying efficiency of the conductive member 5 in the electromagnetic relay 101.

In the above embodiment and the modified examples, in which the first and second holding portions 53, 63 are respectively provided on the lower portions of the first and second extension portions 52b, 62b, have been shown. The first and second holding portions 53, 63 can be disposed at positions different from the configuration of the above embodiment.

In the above embodiment and the modified examples, in which the first and second holding portions 53, 63 are held by the case 2 or the drive device 4, have been shown. The first and second holding portions 53, 63 can be held by the case 2 and the drive device 4.

### REFERENCE SIGNS LIST

1 Electromagnetic relay
2 cases
4 Drive device
5 Conductive member
11 First fixed terminal
12 Second fixed terminal
13 Movable contact piece
41 Coil
42 York
51 First conductive member
52 First energizing portion
52a First connection portion
52b First extension portion
52c First electric-path portion
53 First holding portion
61 Second conductive member
62 Second energizing portion
62a Second connection portion
62b Second extension
62c Second electric circuit portion
63 Second holding portion

1. An electromagnetic relay comprising:
a case;
a drive device disposed inside the case;
a contact device disposed adjacent to the drive device inside the case; and
a conductive member including a current-carrying portion connected to the contact device and forming a current path, and a holding portion provided on the current-carrying portion and held by at least one of the case and the drive device.

2. The electromagnetic relay according to claim 1, wherein
the holding portion is disposed between the case and the drive device and is held by the case.

3. The electromagnetic relay according to claim 1, wherein
the holding portion is disposed between the case and the drive device and is held by the drive device.

4. The electromagnetic relay according to claim 3, wherein
the drive device includes a coil and a yoke which is disposed between the coil and the case, and
the holding portion is fixed to the yoke.

5. The electromagnetic relay according to claim 1, wherein
the contact device includes a first terminal portion and a second terminal portion which is disposed at an interval from the first terminal portion,
the current-carrying portion includes a first current-carrying portion which is connected to the first terminal portion and a second current-carrying portion which is connected to the second terminal portion, and
the holding portion includes a first holding portion which is provided on the first current-carrying portion and a second holding portion which is provided on the second current-carrying portion.
